(19) United States
(12) Patent Application Publication
(10) Pub. No.: US 2008/0167393 A1
(43) Pub. Date: Jul. 10, 2008

(54) Antistatic Treatment of Expandable Polystryrene

(75) Inventors: Markus Allmendinger, Edenkoben (DE); Klaus Hahn, Kirchheim (DE); Joachim Ruch, Wachenheim (DE); Bernhard Schmied, Frankenthal (DE); Jan Holoch, Leimen (DE)

Correspondence Address: Connolly Bove Lodge & Hutz LLP, 1875 Eye Street, NW, Suite 1100, Washington, DC, 20006, US

(73) Assignee: BASF AKTIENGESELLSCHAFT, Ludwigshafen (DE)

(21) Appl. No.: 11/910,888

(22) PCT Filed: Apr. 5, 2006
(86) PCT No.: PCT/EP2006/061350

§ 371 Date: Oct. 5, 2007

(30) Foreign Application Priority Data
Apr. 6, 2005 (DE) 10 2005 015 892.7

(51) Int. Cl. C08J 9/06; B28B 3/26

(52) U.S. Cl. 521/81; 264/297.5

(57) ABSTRACT

The invention relates to a process for producing antistatically treated, expandable styrene polymers, in which a styrene polymer melt is admixed with from 0.05 to 6% by weight of an antistatic and a blowing agent, extruded through a die and pelletized.

The invention relates to a process for producing antistatically treated, expandable styrene polymers.

To make trouble-free transport of expandable polystyrene (EPS) possible and to reduce the electrostatic charge on the prefoamed polystyrene foam particles, the EPS particles are generally coated with an antistatic. Maintaining the antistatic properties of EPS pellets is a recurring problem since the coating agent can be abraded or washed off the surface of the pellets, in particular during the prefoaming process. This in turn leads to unsatisfactory antistatic properties.

It was therefore an object of the present invention to find a process for producing antistatically treated expandable styrene polymers which retain satisfactory antistatic properties even in the case of abrasion and after prefoaming.

We have accordingly found a process for producing antistatically treated, expandable styrene polymers, in which a styrene polymer melt is admixed with from 0.05 to 6% by weight of an antistatic and a blowing agent, extruded through a die and pelletized.

The styrene polymer melt is preferably admixed with from 0.1 to 4% by weight of the antistatic.

Suitable blowing agents are the physical blowing agents customarily used in EPS, e.g. aliphatic hydrocarbons having from 2 to 7 carbon atoms, alcohols, ketones, ethers or halogenated hydrocarbons. Preference is given to using isobutane, n-butane, isopentane, n-pentane. The styrene polymer melt comprising blowing agent generally comprises one or more homogeneously distributed blowing agents in a total amount of from 2 to 10% by weight, preferably from 3 to 7% by weight, based on the styrene polymer melt comprising blowing agent.

Suitable processes for the production of the melt comprising blowing agent, extrusion and pelletization are described, for example, in WO 03/06544.

As antistatic, it is possible to use the substances which are usual and customary in industry. Examples are N,N-bis(2-hydroxyethyl)-C₁₂-C₁₈-alkylamines, diethanolamides of fatty acids, choline ester chlorides of fatty acids, C₁₂-C₂₀-alkylsulfonates, ammonium salts, etc.

Suitable ammonium salts comprise from 1 to 3 hydroxyl-comprising organic radicals in addition to alkyl groups on the nitrogen.

Suitable quaternary ammonium salts are, for example, ones which comprise from 1 to 3, preferably 2, identical or different alkyl radicals having from 1 to 12, preferably from 1 to 10, carbon atoms and from 1 to 3, preferably 2, identical or different hydroxyalkyl or hydroxyalkylpolyoxyalkylene radicals bound to the nitrogen cation and having any anion such as chloride, bromide, acetate, methylsulfate or p-toluenesulfonate.

The hydroxyalkyll and hydroxyalkylpolyoxyalkylene radicals are radicals which are formed by oxyalkylation of a nitrogen-bonded hydrogen atom and are derived from from 1 to 10 oxyalkylene radicals, in particular oxyethylene and oxypropylene radicals.

Particular preference is given to using a quaternary ammonium salt or an alkali metal salt, in particular sodium salt, of a C₁₂-C₂₀-alkanesulfonate, e.g. Emulgator K30 from Bayer AG, or mixtures thereof as antistatic. The antistatics can generally be added either as a pure substance or in the form of an aqueous solution. It is also possible for a coating comprising an antistatic to be additionally applied to the pellets after pelletization.

The antistatics gradually diffuse to the surface of the EPS pellets as a result of phase separation and there ensure, in combination with the residual moisture content of the pellets and/or atmospheric humidity, reliable antistatic properties of the EPS pellets.

Owing to the continuous diffusion of the antistatic from the pellets to the surface, the expandable styrene polymers obtained by the process of the invention have reliable antistatic properties which can regenerate even after possible washing of the antistatic from the surface. In this way, the often unsatisfactory antistatic properties after prefoaming can also be improved.

### EXAMPLES

### Examples 1 to 3 and Comparative Experiments C1 and C2

The amount indicated in table 1 of a mixture of predominantly secondary sodium alkanesulfonates having a mean chain length of C-15 (Emulgator K30 from Bayer AG) as antistatic and 7% by weight of n-pentane as blowing agent were mixed into a polystyrene melt composed of PS 148G from BASF Aktiengesellschaft having a viscosity number VN of 83 ml/g (M_{w}=220 000 g/mol, polydispersity Mw/Mn=2.8). The melt mixture comprising blowing agent was cooled in a cooler from an original 260° C. to 190° C. and extruded at a rate of 60 kg/h through a die plate having 32 holes (diameter of the nozzles=0.75 mm). Compact pellets having a narrow size distribution were produced by means of pressurized underwater pelletization.

The pellets obtained were coated with a coating mixture of glyceryl monostearate, glyceryl tristearate, finely divided silica Aerosil R972, zinc stearate and antistatic Emulgator K30 (200 ppm based on EPS pellets).

The pellets were subsequently prefoamed in flowing steam to give foam beads (18 g/l), stored for 24 hours and subsequently fused by means of steam in gastight molds to produce foam bodies.

The antistatic properties were tested and evaluated (+: satisfactory; −: not satisfactory) via the surface resistance before and about 60 minutes after washing-off of the coating by means of water and subsequent drying.

### EXAMPLE 4

Example 1 was repeated with the difference that 4% by weight of Cesa-stat 3301 (from Clariant) was mixed as antistatic into the polystyrene melt.

### Comparative Experiment C1

Example 1 was repeated with the difference that no antistatic was mixed into the polystyrene melt, but instead only the antistatic Emulgator K 30 was applied via the coating.

TABLE 1
Antistatic properties of the EPS pellets

| | | | Antistatic |
|---|---|---|---|
| | Antistatic mixed in [% | Antistatic properties | properties after |
| Example | by weight] | after coating | washing |
| 1 | 0.5 K 30 | + | + |
| 2 | 1.5 K 30 | + | + |
| 3 | 1.0 K 30 | + | + |
| 4 | 4.0 Cesa-stat 3301 | + | + |
| C1 | 0 | + | − |

1. A process for producing antistatically treated, expandable styrene polymers, which comprises admixing a styrene polymer melt with from 0.05 to 6% by weight of an antistatic and a blowing agent, extruding it through a die and pelletizing it.

2. The process according to claim 1, wherein the styrene polymer melt is admixed with from 0.1 to 4% by weight of an antistatic.

3. The process according to claim 1, wherein a quaternary ammonium salt is used as antistatic.

4. The process according to claim 1, wherein the alkali metal salt of a C₁₂-C₂₀-alkane sulfonate is used.

5. The process according to claim 1, wherein a coating comprising an antistatic is additionally applied to the pellets after pelletization.

6. An antistatically treated, expandable styrene polymer obtainable according claim 1.

7. The process according to claim 2, wherein a quaternary ammonium salt is used as antistatic.

8. The process according to claim 2, wherein the alkali metal salt of a C₁₂-C₂₀-alkane sulfonate is used.

9. The process according to claim 2, wherein a coating comprising an antistatic is additionally applied to the pellets after pelletization.

10. An antistatically treated, expandable styrene polymer obtainable according claim 2.

11. The process according to claim 3, wherein a coating comprising an antistatic is additionally applied to the pellets after pelletization.

12. An antistatically treated, expandable styrene polymer obtainable according claim 3.

13. The process according to claim 4, wherein a coating comprising an antistatic is additionally applied to the pellets after pelletization.

14. An antistatically treated, expandable styrene polymer obtainable according claim 4.
